(19) United States
(12) Patent Application Publication
(10) Pub. No.: US 2025/0370945 A1
(43) Pub. Date: Dec. 4, 2025

(54) OPTIMIZED TRANSMISSION OF PRIORITY PACKETS VIA UNIVERSAL CHIPLET INTERCONNECT EXPRESS (UCIE) SIDEBAND LINK

(71) Applicants: Swadesh CHOUDHARY, Mountain View, CA (US); Debendra DAS SHARMA, Saratoga, CA (US); Lakshmipriya SESHAN, Sunnyvale, CA (US); Peter ONUFRYK, Flanders, NJ (US)

(72) Inventors: Swadesh CHOUDHARY, Mountain View, CA (US); Debendra DAS SHARMA, Saratoga, CA (US); Lakshmipriya SESHAN, Sunnyvale, CA (US); Peter ONUFRYK, Flanders, NJ (US)

(21) Appl. No.: 19/300,461

(22) Filed: Aug. 14, 2025

Related U.S. Application Data
(60) Provisional application No. 63/682,976, filed on Aug. 14, 2024.

(51) Int. Cl. G06F 13/38

(52) U.S. Cl. CPC G06F 13/382; G06F 2213/38

(57) ABSTRACT

This disclosure describes systems, methods, and devices related to priority packet optimization. A device may receive a trigger indicating a switch to a high priority data transfer based on a clock signal remaining at a predetermined logic value for a defined number of unit intervals. The device may transmit a priority vector from a transmitter to a receiver, the priority vector comprising a plurality of bits, wherein a bit is transmitted during a respective clock cycle and a clock toggles during transmission. The device may receive a trigger indicating a resumption of a previous data transfer based on the clock signal again remaining at the predetermined logic value for the defined number of unit intervals. The device may format the priority vector as a sideband packet comprising an opcode and reserved fields before forwarding to upper protocol layers.

### CROSS-REFERENCE TO RELATED APPLICATION(S)

This application claims the benefit of U.S. Provisional Application No. 63/682,976, filed Aug. 14, 2024, the disclosure of which is incorporated herein by reference as if set forth in full.

### BACKGROUND

Advancements in high-speed data transfer protocols are essential in meeting the growing needs of complex computing systems. The continuous evolution of connectivity standards is critical for enabling peak performance and reliability in data exchange. There is an inherent need to refine these protocols to support the efficient handling of data across advanced communication interfaces.

### BRIEF DESCRIPTION OF THE DRAWINGS

FIGS. 1-3 depict illustrative schematic diagrams for priority packet optimization, in accordance with one or more example embodiments of the present disclosure.

FIG. 4 illustrates a flow diagram of an illustrative process for a priority packet optimization system, in accordance with one or more example embodiments of the present disclosure.

FIG. 5 is a block diagram illustrating an example of a computing device or computing system upon which any of one or more techniques (e.g., methods) may be performed, in accordance with one or more example embodiments of the present disclosure.

FIG. 6 illustrates an embodiment of a block diagram for a computing system including a processor, in accordance with one or more example embodiments of the present disclosure.

FIG. 7 illustrates an example system implemented as system on chip (SoC), in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Universal Chiplet Interconnect Express (UCIe) is an industry standard pivotal in the evolution of integrated circuit design. It establishes protocols for chiplets—small blocks of integrated circuits—to interconnect within a single package. By leveraging standards like PCI Express (PCIe) and Compute Express Link (CXL), UCIe facilitates die-to-die serial connections that enable these chiplets to communicate effectively. The aim is to provide a scalable solution for creating larger, more complex System-on-Chips (SoCs) that go beyond the constraints of maximum reticle size. With UCIe, manufacturers gain the flexibility to combine chiplets from various sources, paving the way for more modular and easily upgradeable SoCs.

There is a need for low latency notifications over UCIe sideband (<100 ns) for things like Thermal trip, Power down or wake events, time synchronization, telemetry, security faults or debug triggers etc. The current behavior of UCIe sideband (which operates as a single data wire and clock running at 800 MHZ) forces serialization of packets and since some packets can be as long as 512b, the latency can be as high as 640 ns before the transmitter gets a chance to send another packet.

In one or more embodiments, a priority packet optimization system may define a mechanism to allow priority packets to be sent in the middle of another packet without resulting in aliasing (i.e. not relying on any specific pattern on the data lane).

Example embodiments of the present disclosure relate to systems, methods, and devices for transmitting priority packets over the UCIe sideband Link.

In one embodiment, a priority packet optimization system may facilitate at least the following:
A method to interrupt packets in flight at a 16 unit interval (UI) (or multiple) boundary. This involves sending a trigger on the clock lane—in this case the absence of the clock pattern for 4UI interval.
The receiver detects this and sets a flag to interpret future data transfers as a priority vector transfer.
Once the data transfers are completed, the transmitter sends another trigger on the clock lane (the absence of the clock pattern for a 4UI interval) to inform the receiver that the original interrupted packet will resume.

Different lengths of clock pattern absence (for example 4UI, 8UI etc.) can be treated as separated triggers for different types of data transfer patterns if needed (or even as a way to indicate that the data lane will carry some analog event trigger).

One or more advantages of this priority packet optimization approach is that it eliminates the need for dedicated bumps to handle specific use cases, which in turn can significantly reduce the number of GPIOs required on chiplets. Additionally, this method maintains ultra-low latency for urgent notifications, even when other data traffic is present, ensuring rapid and efficient communication for critical events.

In one or more embodiments, the priority packet optimization system can be used to transmit urgent notifications, such as thermal trip alerts, power-down events, or security fault signals, without delay. For example, when a chiplet detects a sudden increase in temperature that requires immediate attention, the transmitter can interrupt the current packet transmission and send a priority alert using the clock lane trigger described above. This ensures that the notification is received and acted upon almost instantly.

In one or more embodiments, the use of clock lane triggers to denote priority transfers allows multiple types of events to be signaled using different lengths of clock inactivity. For example, a 4UI absence can indicate a thermal event, while an 8UI absence might signal a power-down event. This approach enables the system to distinguish between various critical notifications and respond appropriately, all while using the same two-pin protocol.

In one or more embodiments, this system optimizes chiplet communications by minimizing the need for extra physical connections. For example, instead of adding more GPIO pins for each possible event, the system uses the existing clock and data lanes to handle both regular and urgent transfers. This not only streamlines the chiplet design but also maintains low latency for high-priority signals, allowing manufacturers to efficiently build scalable and modular SoCs.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

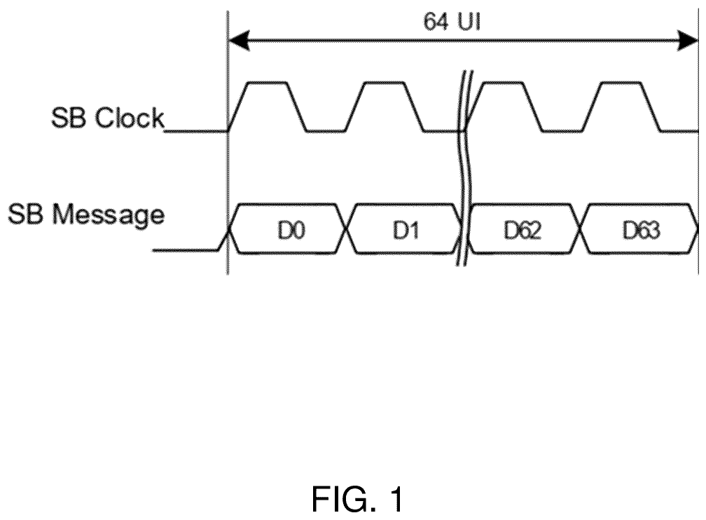

FIGS. 1-3 depict illustrative schematic diagrams for priority packet optimization, in accordance with one or more example embodiments of the present disclosure.

UCIe sideband works as a two-pin protocol with a clock and a data lane. Clock is idle if there is no data transfer.

FIG. 1 shows an example transfer of 64UI of a sideband packet. Clock operates at a fixed frequency of 800 MHZ.

Currently, the maximum size of transfer for a packet over this Link is 512 bits. At a frequency of 800 MHZ, this is 640 ns of transmit time. an important property to utilize is that a 64UI transfer is contiguous—there is no pausing the clock in the middle of a transfer currently in the UCIe.

In order to define a mechanism for priority transfer of low latency events, there are three main aspects involved:
1) A trigger from the transmitter is used to indicate that it is switching to a high priority transfer. For example, this trigger takes the form of the clock line remaining at logic 0 (also referred to as 0b) for a duration of 4UI (Unit Intervals) before starting the priority transfer. The receiver can implement a simple gray counter that increments with each clock cycle it receives. A gray counter is a specialized binary counter in which only one bit changes state between successive values, making it particularly useful for synchronizing signals between different clock domains without error.

If the receiver detects that the counter does not increment for a couple of cycles within the sampled domain while a sideband packet is in progress, it sets a flag to expect an incoming priority transfer. For example, if normal data is being sent and suddenly the clock goes idle for 4UI, the receiver's gray counter will notice the pause and prepare to receive a priority message next. There are other possible ways to implement receiver tracking, but this is one example to illustrate how the signaling could work. It should be noted that both “logic 0” and “0b” are expressions used in digital electronics to denote the binary low state. “Logic 0” refers to a signal or voltage level recognized as zero, or “off,” in a circuit, while “0b” is a notation used in programming and technical documentation to represent binary numbers, with “0b0” specifically indicating binary zero. In hardware contexts, saying a signal remains at “logic 0” or at “0b” both mean the signal is being held at the binary low level, so these terms are essentially interchangeable. Whether describing a physical voltage or a software value, each term conveys the same concept: a deasserted, inactive, or low state integral to all digital signaling and communications.
2) After the trigger, the transmitter sends the priority vector to the receiver. For example, in this case, the vector is 24 bits long and transmitted over 24 UI, with the clock toggling and one data bit sent per clock cycle. For example, if the priority vector is 0xA35F13 (hexadecimal), the transmitter starts sending each bit one at a time, with the data line representing each successive bit for each clock cycle, until all 24 bits have been sent.
3) When the priority transfer is complete and the transmitter needs to switch back to the original, lower priority packet, it sends another trigger. This is done by keeping the clock line at logic 0 for another 4UI before resuming normal transmission. For example, after the 24 bits of the priority vector are sent, the transmitter holds the clock low for 4UI, and then resumes sending the remainder of the interrupted packet. This way, the receiver can easily recognize that the priority message is finished and that regular communication is continuing.

These steps together allow the system to reliably send urgent notifications without ambiguity, using clear signals and sequences on the clock and data lanes. For example, thermal trip alerts or power-down events can be sent immediately by briefly pausing the clock, sending the priority vector, and then pausing again before continuing with normal data flow. This ensures that critical communications are handled rapidly and efficiently, even when regular data is also being transmitted.

Note that the duration of the clock being held at 0b, such as for 4UI, 8UI, or more, can be used to create distinct types of trigger signals for initiating different types of priority transfers. This means that the length of time the clock remains at the low binary state allows the transmitter and receiver to differentiate between various urgent notifications or events that need to be communicated immediately. For example, if a notification needs to be sent as an analog transmission or as an asynchronous trigger rather than a standard synchronous message, the transmitter can hold the clock at 0b for a longer period (such as 8UI instead of 4UI) to indicate a different event type. The receiver, in response to detecting this longer or shorter pause, can switch its sampling method to handle the specific event being triggered.

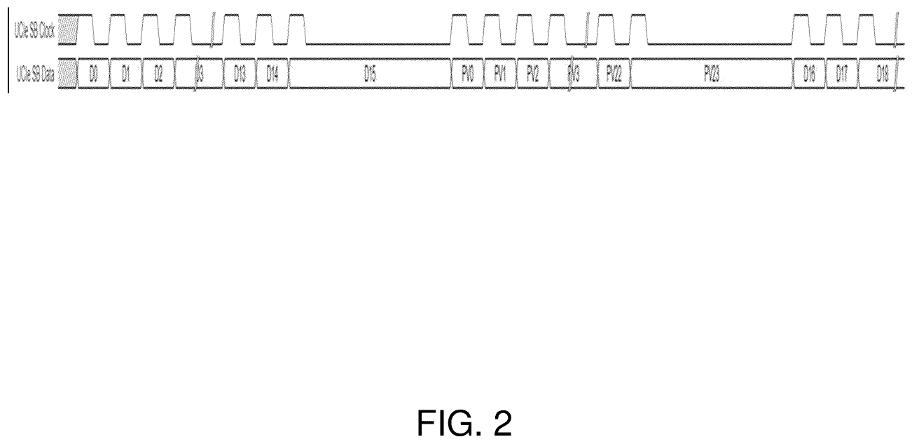

For instance, if a thermal trip alert is sent, the clock line may be held low for exactly 4UI before the priority vector is transmitted, signaling the receiver to prepare for a quick, synchronous priority transfer. If a power-down event needs to be sent, the transmitter might use a longer duration, such as 8UI, to signal the receiver to expect an asynchronous notification. In both cases, the receiver adjusts its internal logic to interpret and process the incoming information correctly based on the trigger's duration. An example of this variable trigger approach is shown in FIG. 2, where each bit of the priority vector (referred to as PVi for the ith bit) is transmitted according to the event type signaled by the clock's behavior.

In FIG. 2, there is shown a UCIe SB Clock (top portion of FIG. 2), and a UCIe SB Data (bottom portion of FIG. 2). The UCIe SB Data sequence is shown for illustration only, is D0, D1, D2, D3, . . . , D13, D14, D15, PV0, PV1, PV2, PV3, . . . , PV22, PV23, D16, D17, D18, . . . . The D15 and PV23 are show to be longer than the other blocks.

This mechanism provides flexibility for the system to handle multiple types of urgent messages efficiently, ensuring that each event is communicated with the appropriate timing and processing method as required by the situation.

It is the responsibility of the receiving Physical layer to format the priority vector as a UCIe sideband packet before forwarding it to the upper layers over the RDI config bus. For example, after the Physical layer detects a priority transfer, it takes the 24-bit priority vector and arranges it into the specific format required by the UCIe protocol for sideband packets, ensuring all necessary fields are included so that the upper layers can process the message correctly.

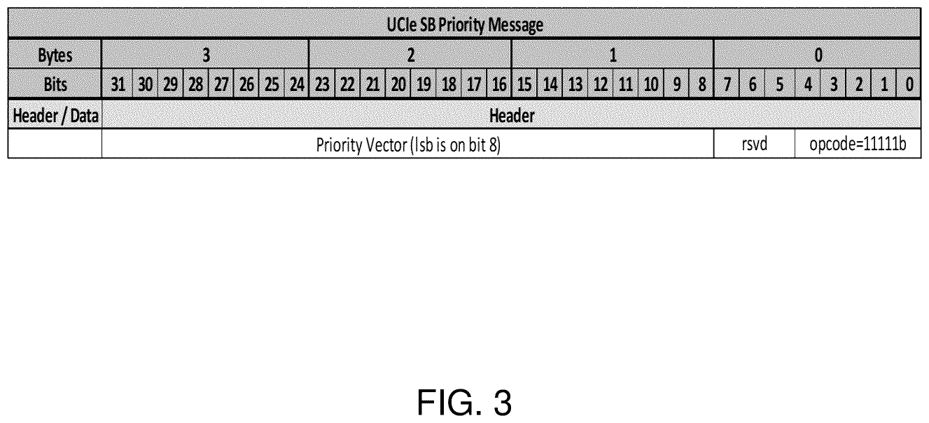

The UCIe sideband packet looks as follows (see FIG. 3) for this purpose—the routing is implicit based on the opcode. For example, if the opcode indicates a thermal alert, the sideband packet will be routed automatically to the thermal management logic without needing separate routing instructions.

If the sideband link is idle to begin with, then the entire message is transmitted in full, including the opcode and reserved fields. For example, when no normal packet transmission is happening, the system sends the priority packet with both its opcode and reserved bits, so the receiver is able to interpret the packet type and any specialized instructions contained within.

The Physical layer determines the length of the transfer by checking the opcode; for example, a 32b transfer is identified by a specific opcode value, so the receiver knows to expect a 32-bit packet and processes it accordingly. An opcode, short for “operation code,” is a unique identifier within a data packet or instruction set that specifies the particular operation or command to be executed by a processor or receiver.

Bit 23 of the priority vector is used as a parity bit to check for errors during transmission. For example, if the priority vector is sent alone (interrupting a different packet), the parity is calculated by XOR'ing bits 22:0 of the priority vector, allowing the receiver to verify integrity. If the full UCIe Sideband Priority message is transferred, the parity is calculated by also XOR'ing the reserved and opcode bits along with bits 22:0. This gives the receiver a broader error check, ensuring that all critical fields of the packet are transmitted correctly.

For example, if the system needs to send an urgent thermal trip alert, the process involves formatting the priority vector, assembling the sideband packet with the appropriate opcode for a thermal event, transmitting the packet when the link is idle, and calculating the parity for error checking. The receiver then validates the packet, interprets the opcode, and passes the message to the thermal management unit for immediate action.

This approach ensures that all urgent notifications, such as power-down events or hardware faults, are transmitted clearly and reliably, with built-in mechanisms for routing and data integrity, enabling the system to respond rapidly to critical conditions.

It is understood that the above descriptions are for the purposes of illustration and are not meant to be limiting.

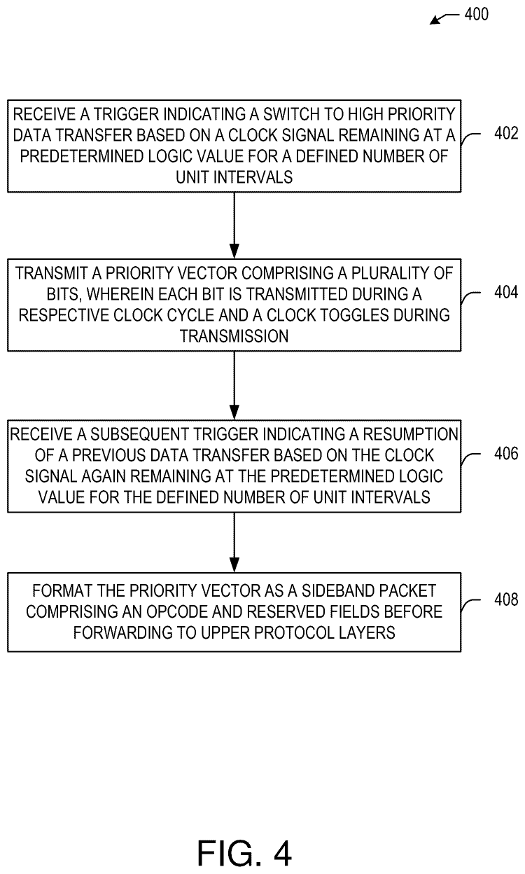

FIG. 4 illustrates a flow diagram of illustrative process 400 for a priority packet optimization system, in accordance with one or more example embodiments of the present disclosure.

At block 402, a device may receive a trigger indicating a switch to high priority data transfer based on a clock signal remaining at a predetermined logic value for a defined number of unit intervals.

At block 404, the device may transmit a priority vector comprising a plurality of bits, wherein each bit is transmitted during a respective clock cycle and a clock toggles during transmission.

At block 406, the device may receive a subsequent trigger indicating a resumption of a previous data transfer based on the clock signal again remaining at the predetermined logic value for the defined number of unit intervals.

At block 408, the device may format the priority vector as a sideband packet comprising an opcode and reserved fields before forwarding to upper protocol layers;
In one or more embodiments, a device or a system may implement a counter to detect an absence of clock signal increments over a defined number of unit intervals, using this absence as a trigger for particular operations. For example, when the clock remains unchanged for 4 UI, the device may initiate a switch to high-priority data transfer, ensuring critical information is relayed promptly even when routine communication is ongoing. This approach may solve timing ambiguities that can arise in high-speed interconnects, where precise triggers are necessary for effective priority handling.

In one or more embodiments, the device or system may define multiple triggers by varying the duration that the clock signal remains at a predetermined logic value, thereby distinguishing between different types of events, such as analog or asynchronous notifications. This flexibility may allow for more granular control over event handling, which can be particularly useful in complex systems that require simultaneous attention to a range of activities. For instance, a short clock pause may indicate an analog event while a longer pause may signal a need for asynchronous priority escalation.

In one or more embodiments, the clock signal may operate at a fixed frequency—such as 800 MHZ—to maintain synchronization, and the defined number of unit intervals for specific triggers may be set, for instance, at 4 UI. The device or system may transmit a priority vector comprising a plurality of bits, and each bit may be sent during a respective clock cycle, with the clock toggling to indicate the flow of information. This structure may simplify the detection and interpretation of high-priority commands.

In one or more embodiments, the priority vector may include 24 bits and may feature a parity bit computed by XOR'ing the other bits, providing a simple method to verify data integrity. For full sideband priority message transfers, a parity calculation may also incorporate reserved and opcode bits, addressing the need for robust error checking in noisy environments. For example, a parity mismatch may immediately alert the system to transmission errors.

In one or more embodiments, the device may format the priority vector as a sideband packet for routing based on opcode, and if the sideband link is idle, the packet may include both opcode and reserved fields. This design may ensure that priority information is reliably delivered to upper protocol layers, maintaining system responsiveness and correctness. For instance, a sudden need to preempt regular packet flow can be clearly conveyed to all relevant subsystems through this mechanism.

It is understood that the above descriptions are for the purposes of illustration and are not meant to be limiting.

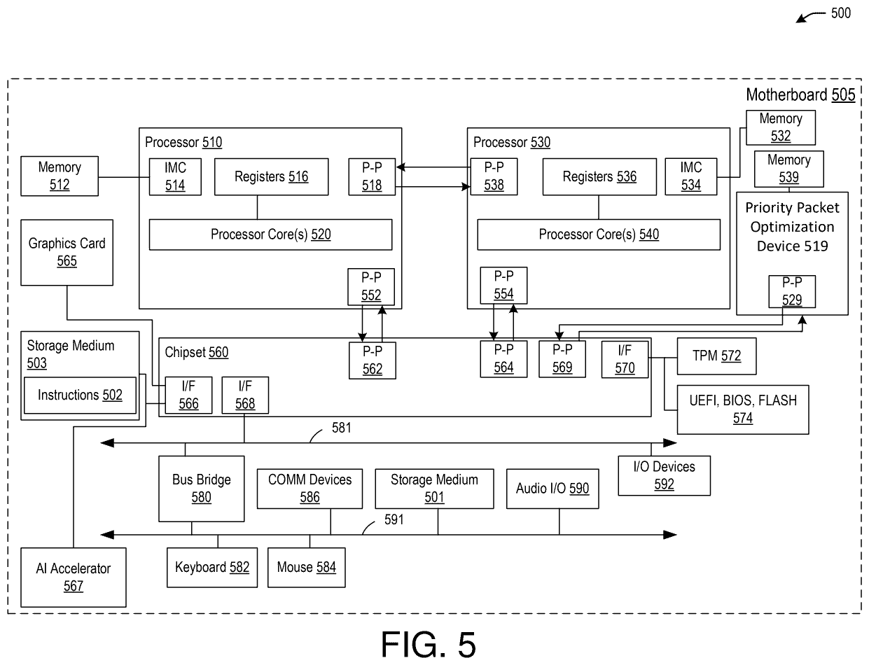

FIG. 5 illustrates an embodiment of an exemplary system 500, in accordance with one or more example embodiments of the present disclosure.

In various embodiments, the computing system 500 may comprise or be implemented as part of an electronic device.

The embodiments are not limited in this context. More generally, the computing system 500 is configured to implement all logic, systems, processes, logic flows, methods, equations, apparatuses, and functionality described herein.

The system 500 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 500 may have a single processor with one core or more than one processor. Note that the term “processor” refers to a processor with a single core or a processor package with multiple processor cores.

The computing system 500 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 500. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 500 comprises a motherboard 505 for mounting platform components. The motherboard 505 is a point-to-point interconnect platform that includes a processor 510, a processor 530 coupled via a point-to-point interconnects as an Ultra Path Interconnect (UPI), and a priority packet optimization device 519. In other embodiments, the system 500 may be of another bus architecture, such as a multi-drop bus. Furthermore, each of processors 510 and 530 may be processor packages with multiple processor cores. As an example, processors 510 and 530 are shown to include processor core(s) 520 and 540, respectively. While the system 500 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 510 and the chipset 560. Some platforms may include additional components and some platforms may only include sockets to mount the processors and/or the chipset.

The processors 510 and 530 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 510, and 530.

The processor 510 includes an integrated memory controller (IMC) 514, registers 516, and point-to-point (P-P) interfaces 518 and 552. Similarly, the processor 530 includes an IMC 534, registers 536, and P-P interfaces 538 and 554. The IMC's 514 and 534 couple the processors 510 and 530, respectively, to respective memories, a memory 512 and a memory 532. The memories 512 and 532 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 512 and 532 locally attach to the respective processors 510 and 530.

In addition to the processors 510 and 530, the system 500 may include a priority packet optimization device 519. The priority packet optimization device 519 may be connected to chipset 560 by means of P-P interfaces 529 and 569. The priority packet optimization device 519 may also be connected to a memory 539. In some embodiments, the priority packet optimization device 519 may be connected to at least one of the processors 510 and 530. In other embodiments, the memories 512, 532, and 539 may couple with the processor 510 and 530, and the priority packet optimization device 519 via a bus and shared memory hub.

System 500 includes chipset 560 coupled to processors 510 and 530. Furthermore, chipset 560 can be coupled to storage medium 503, for example, via an interface (I/F) 566. The I/F 566 may be, for example, a Peripheral Component Interconnect-enhanced (PCI-c). The processors 510, 530, and the priority packet optimization device 519 may access the storage medium 503 through chipset 560.

It should be noted that PCIe, UCIe, and CXL are distinct standards in computing, each serving specific functions. PCIe, or Peripheral Component Interconnect Express, is a widely adopted serial computer expansion bus standard. It's integral for connecting high-speed components such as graphics cards, SSDs, and network cards to a motherboard, known for its scalability and efficient data transfer rates. Its point-to-point configuration reduces bottlenecks, making it highly effective. In contrast, UCIe, or Universal Chiplet Interconnect Express, is a more recent development. It standardizes the interconnect between chiplets within a single package. Chiplets are small, modular silicon blocks with specific functions, assembled to form a complex chip. UCIe's primary aim is to streamline chiplet communication, fostering the design and creation of more efficient and powerful processors through modular integration. CXL, or Compute Express Link, focuses on high-speed, low-latency connections between CPUs and various devices like workload accelerators, memory buffers, and smart I/O devices. While leveraging the PCIe interface for its physical and electrical aspects, CXL is tailored for advanced computing tasks requiring intensive data processing, such as AI and machine learning. Its ability to efficiently share memory among various components is a key feature, marking its importance in the realm of data-intensive computing. Together, these technologies represent the diverse needs and advancements in computer hardware, from general expansion capabilities to specialized data processing and modular chip design. PCIe's established presence contrasts with the emerging roles of UCIe and CXL, highlighting the dynamic and evolving nature of computer technology.

Storage medium 503 may comprise any non-transitory computer-readable storage medium or machine-readable storage medium, such as an optical, magnetic or semiconductor storage medium. In various embodiments, storage medium 503 may comprise an article of manufacture. In some embodiments, storage medium 503 may store computer-executable instructions, such as computer-executable instructions 502 to implement one or more of processes or operations described herein, (e.g., process XZY00 of FIG. XZY). The storage medium 503 may store computer-executable instructions for any equations depicted above. The storage medium 503 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 510 couples to a chipset 560 via P-P interfaces 552 and 562 and the processor 530 couples to a chipset 560 via P-P interfaces 554 and 564. Direct Media Interfaces (DMIs) may couple the P-P interfaces 552 and 562 and the P-P interfaces 554 and 564, respectively. The DMI may be a high-speed interconnect that facilitates, e.g., eight Giga Transfers per second (GT/s) such as DMI 3.0. In other embodiments, the processors 510 and 530 may interconnect via a bus.

The chipset 560 may comprise a controller hub such as a platform controller hub (PCH). The chipset 560 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 560 may comprise more than one controller hub such as a chipset with a memory controller hub, a graphics controller hub, and an input/output (I/O) controller hub.

In the present embodiment, the chipset 560 couples with a trusted platform module (TPM) 572 and the UEFI, BIOS, Flash component 574 via an interface (I/F) 570. The TPM 572 is a dedicated microcontroller designed to secure hardware by integrating cryptographic keys into devices. The UEFI, BIOS, Flash component 574 may provide pre-boot code.

Furthermore, chipset 560 includes the I/F 566 to couple chipset 560 with a high-performance graphics engine, graphics card 565. In other embodiments, the system 500 may include a flexible display interface (FDI) between the processors 510 and 530 and the chipset 560. The FDI interconnects a graphics processor core in a processor with the chipset 560.

Various I/O devices 592 couple to the bus 581, along with a bus bridge 580 which couples the bus 581 to a second bus 591 and an I/F 568 that connects the bus 581 with the chipset 560. In one embodiment, the second bus 591 may be a low pin count (LPC) bus. Various devices may couple to the second bus 591 including, for example, a keyboard 582, a mouse 584, communication devices 586, a storage medium 501, and an audio I/O 590.

The artificial intelligence (AI) accelerator 567 may be circuitry arranged to perform computations related to AI. The AI accelerator 567 may be connected to storage medium 503 and chipset 560. The AI accelerator 567 may deliver the processing power and energy efficiency needed to enable abundant-data computing. The AI accelerator 567 is a class of specialized hardware accelerators or computer systems designed to accelerate artificial intelligence and machine learning applications, including artificial neural networks and machine vision. The AI accelerator 567 may be applicable to algorithms for robotics, internet of things, other data-intensive and/or sensor-driven tasks.

Many of the I/O devices 592, communication devices 586, and the storage medium 501 may reside on the motherboard 505 while the keyboard 582 and the mouse 584 may be add-on peripherals. In other embodiments, some or all the I/O devices 592, communication devices 586, and the storage medium 501 are add-on peripherals and do not reside on the motherboard 505.

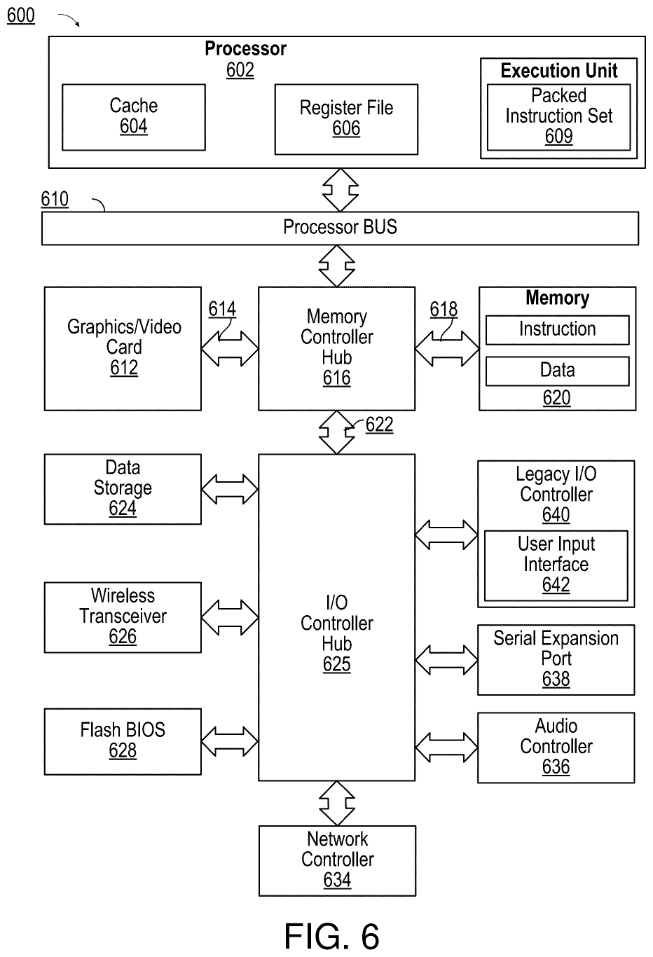

Turning to FIG. 6, a block diagram of an exemplary computer system formed with a processor that includes execution units to execute an instruction, where one or more of the interconnects implement one or more features in accordance with one embodiment of the present disclosure is illustrated. System 600 includes a component, such as a processor 602 to employ execution units including logic to perform algorithms for process data, in accordance with the present disclosure, such as in the embodiment described herein. In one embodiment, sample system 600 executes a version of an operating system and included software, and provides corresponding graphical user interfaces, may also be used. However, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 602 includes one or more execution units 608 to implement an algorithm that is to perform at least one instruction. One embodiment may be described in the context of a single processor desktop or server system, but alternative embodiments may be included in a multiprocessor system. System 600 is an example of a ‘hub’ system architecture. The computer system 600 includes a processor 602 to process data signals. The processor 602, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 602 is coupled to a processor bus 610 that transmits data signals between the processor 602 and other components in the system 600. The elements of system 600 (e.g. graphics accelerator 612, memory controller hub 616, memory 620, I/O controller hub 625, wireless transceiver 626, Flash BIOS 628, Network controller 634, Audio controller 636, Serial expansion port 638, I/O controller 640, etc.) perform their conventional functions that are well known to those familiar with the art.

In one embodiment, the processor 602 includes a Level 1 (L1) internal cache memory 604. Depending on the architecture, the processor 602 may have a single internal cache or multiple levels of internal caches. Other embodiments include a combination of both internal and external caches depending on the particular implementation and needs. Register file 606 is to store different types of data in various registers including integer registers, floating point registers, vector registers, banked registers, shadow registers, checkpoint registers, status registers, and instruction pointer register.

Execution unit 608, including logic to perform integer and floating point operations, also resides in the processor 602. The processor 602, in one embodiment, includes a microcode (ucode) ROM to store microcode, which when executed, is to perform algorithms for certain macroinstructions or handle complex scenarios. Here, microcode is potentially updateable to handle logic bugs/fixes for processor 602. For one embodiment, execution unit 608 includes logic to handle a packed instruction set 609. By including the packed instruction set 609 in the instruction set of a general-purpose processor 602, along with associated circuitry to execute the instructions, the operations used by many multimedia applications may be performed using packed data in a general-purpose processor 602. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 608 may also be used in micro controllers, embedded processors, graphics devices, DSPs, and other types of logic circuits. System 600 includes a memory 620. Memory 620 includes a dynamic random access memory (DRAM) device, a static random access memory (SRAM) device, flash memory device, or other memory device. Memory 620 stores instructions and/or data represented by data signals that are to be executed by the processor 602.

Note that any of the aforementioned features or aspects of the present disclosure and solutions may be utilized on one or more interconnect illustrated in FIG. 6. For example, an on-die interconnect (ODI), which is not shown, for coupling internal units of processor 602 implements one or more aspects of the embodiments described above. Or the embodiments may be associated with a processor bus 610 (e.g. other known high performance computing interconnect), a high bandwidth memory path 618 to memory 620, a point-to-point link to graphics accelerator 612 (e.g. a Peripheral Component Interconnect express (PCIe) compliant fabric), a controller hub interconnect 622, an I/O or other interconnect (e.g. USB, PCI, PCIe) for coupling the other illustrated components. Some examples of such components include the audio controller 636, firmware hub (flash BIOS) 628, wireless transceiver 626, data storage 624, legacy I/O controller 640 containing user input and keyboard interfaces 642, a serial expansion port 638 such as Universal Serial Bus (USB), and a network controller 634. The data storage device 624 can comprise a hard disk drive, a floppy disk drive, a CD-ROM device, a flash memory device, or other mass storage device.

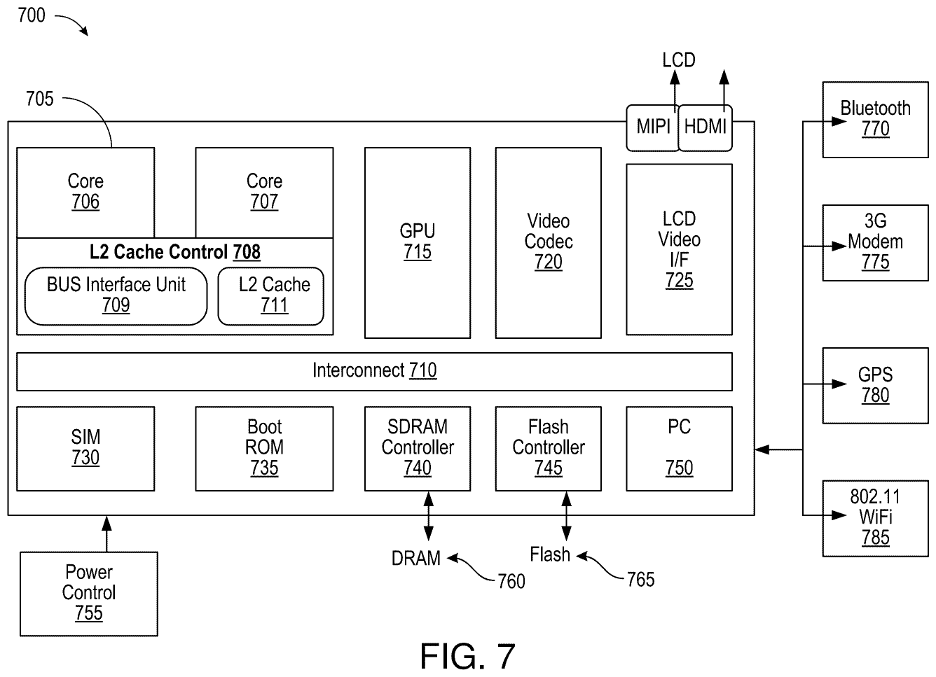

Turning next to FIG. 7, an embodiment of a system on-chip (SOC) design in accordance with the above disclosure is depicted. As a specific illustrative example, SOC 700 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 700 includes 2 cores—706 and 707. Similar to the discussion above, cores 706 and 707 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 706 and 707 are coupled to cache control 708 that is associated with bus interface unit 709 and L2 cache 711 to communicate with other parts of system 700. Interconnect 710 includes an on-chip interconnect, such as an IOSF, AMBA, or other interconnect discussed above, which potentially implements one or more aspects described herein.

Interface 710 provides communication channels to the other components, such as a Subscriber Identity Module (SIM) 730 to interface with a SIM card, a boot ROM 735 to hold boot code for execution by cores 706 and 707 to initialize and boot SOC 700, a SDRAM controller 740 to interface with external memory (e.g. DRAM 760), a flash controller 745 to interface with non-volatile memory (e.g. Flash 765), a peripheral control 750 (e.g. Serial Peripheral Interface) to interface with peripherals, video codecs 720 and Video interface 725 to display and receive input (e.g. touch enabled input), GPU 715 to perform graphics related computations, etc. Any of these interfaces may incorporate aspects of the embodiments described herein.

In addition, the system illustrates peripherals for communication, such as a Bluetooth module 770, 3G modem 775, GPS 780, and WiFi 785. Note as stated above, a UE includes a radio for communication. As a result, these peripheral communication modules are not all required. However, in a UE some form of radio for external communication is to be included.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a system for transmitting priority packets over a sideband link, comprising a transmitter configured to generate and transmit a clock signal and data signal, and a receiver configured to monitor the clock signal and detect an absence of clock transitions for a predetermined unit interval as a trigger to switch to a priority packet transfer, wherein the transmitter is further configured to transmit a priority vector as a series of data bits following said trigger, and wherein the transmitter and receiver are configured to resume transmission of original packet in response to detection of a subsequent trigger comprising an absence of clock transitions for the predetermined unit interval.

Example 2 may include the system of example 1 and/or some other example(s) herein, wherein the predetermined unit interval for triggering priority transfer is 4 unit intervals.

Example 3 may include the system of example 1 and/or some other example(s) herein, wherein the priority vector comprises 24 bits, including a parity bit.

Example 4 may include the system of example 1 and/or some other example(s) herein, wherein the receiver implements a gray counter to detect the absence of clock transitions.

Example 5 may include the system of example 1 and/or some other example(s) herein, wherein a duration of a clock signal absence may be varied to distinguish different types of triggers, including analog or asynchronous event notifications.

Example 6 may include the system of example 1 and/or some other example(s) herein, wherein the receiver is configured to format the priority vector as a sideband packet before forwarding it to upper layers over a configuration bus.

Example 7 may include the system of example 1 and/or some other example(s) herein, wherein the transmitter computes a parity bit for the priority vector by performing an XOR operation on bits 22:0 of the priority vector.

Example 8 may include the system of example 1 and/or some other example(s) herein, wherein, for full sideband priority message transfers, a parity computation further includes XOR with reserved and opcode bits.

Example 9 may include the system of example 1 and/or some other example(s) herein, wherein the transmitter and receiver are configured to interrupt regular packet transmission at a 16 unit interval boundary for priority transfer.

Example 10 may include an apparatus comprising processing circuitry, the apparatus configured to perform operations comprising: receiving a trigger indicating a switch to a high priority data transfer based on a clock signal remaining at a predetermined logic value for a defined number of unit intervals; transmitting a priority vector from a transmitter to a receiver, the priority vector comprising a plurality of bits, wherein each bit is transmitted during a respective clock cycle and a clock toggles during transmission; receiving a trigger indicating a resumption of a previous data transfer based on the clock signal again remaining at the predetermined logic value for the defined number of unit intervals; and formatting the priority vector as a sideband packet comprising an opcode and reserved fields before forwarding to upper protocol layers.

Example 11 may include the apparatus of example 10 and/or some other example(s) herein, wherein the processing circuitry implements a counter to detect a lack of clock signal increments for the defined number of unit intervals as the trigger.

Example 12 may include the apparatus of example 10 and/or some other example(s) herein, wherein multiple different triggers are defined by varying a duration of the clock signal remaining at the predetermined logic value.

Example 13 may include the apparatus of example 10 and/or some other example(s) herein, wherein the clock signal operates at a fixed frequency of 800 MHZ.

Example 14 may include the apparatus of example 10 and/or some other example(s) herein, wherein the defined number of unit intervals for the trigger is 4 unit intervals.

Example 15 may include the apparatus of example 10 and/or some other example(s) herein, wherein the priority vector comprises 24 bits.

Example 16 may include the apparatus of example 10 and/or some other example(s) herein, wherein the priority vector includes a parity bit computed by XOR'ing the remaining bits of the priority vector.

Example 17 may include the apparatus of example 10 and/or some other example(s) herein, wherein the priority vector is formatted as a sideband packet for routing based on an opcode.

Example 18 may include the apparatus of example 10 and/or some other example(s) herein, wherein if a sideband link is idle, the sideband packet includes both the opcode and reserved fields.

Example 19 may include a method for optimizing priority packet transmission, the method comprising: receiving, by processing circuitry, a trigger indicating a switch to high priority data transfer based on a clock signal remaining at a predetermined logic value for a defined number of unit intervals; transmitting a priority vector comprising a plurality of bits, wherein each bit is transmitted during a respective clock cycle and a clock toggles during transmission; receiving a subsequent trigger indicating a resumption of a previous data transfer based on the clock signal again remaining at the predetermined logic value for the defined number of unit intervals; and formatting the priority vector as a sideband packet comprising an opcode and reserved fields before forwarding to upper protocol layers.

Example 20 may include the method of example 19 and/or some other example(s) herein, further comprising implementing a counter to detect a lack of clock signal increments for the defined number of unit intervals as the trigger.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-20, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for transmitting priority packets over a Universal Chiplet Interconnect Express (UCIe) sideband link, comprising:
a transmitter configured to generate and transmit a clock signal and data signal over the sideband link;
a receiver configured to monitor the clock signal and detect an absence of clock transitions for a predetermined unit interval as a trigger to switch to a priority packet transfer;
wherein the transmitter further configured to transmit a priority vector as a series of data bits following the trigger; and
wherein the transmitter and receiver configured to resume transmission of original packet in response to a detection of a subsequent trigger comprising an absence of clock transitions for the predetermined unit interval.

2. The system of claim 1, wherein the predetermined unit interval for triggering priority transfer is 4 unit intervals (UI).

3. The system of claim 1, wherein the priority vector comprises 24 bits, including a parity bit.

4. The system of claim 1, wherein the receiver implements a gray counter to detect the absence of clock transitions.

5. The system of claim 1, wherein a duration of a clock signal absence may be varied to distinguish different types of triggers, including analog or asynchronous event notifications.

6. The system of claim 1, wherein the receiver is configured to format the priority vector as a UCIe sideband packet before forwarding it to upper layers over an RDI configuration bus.

7. The system of claim 1, wherein the transmitter computes a parity bit for the priority vector by performing an XOR operation on bits 22:0 of the priority vector.

8. The system of claim 1, wherein, for full UCIe sideband priority message transfers, a parity computation further includes XOR with reserved and opcode bits.

9. The system of claim 1, wherein the transmitter and receiver are configured to interrupt regular packet transmission at a 16UI boundary for priority transfer.

10. An apparatus comprising processing circuitry, the apparatus configured to perform operations comprising:
receive a trigger indicating a switch to a high priority data transfer based on a clock signal remaining at a predetermined logic value for a defined number of unit intervals;
transmit a priority vector from a transmitter to a receiver, the priority vector comprising a plurality of bits, wherein a bit is transmitted during a respective clock cycle and a clock toggles during transmission;
receive a trigger indicating a resumption of a previous data transfer based on the clock signal again remaining at the predetermined logic value for the defined number of unit intervals; and
format the priority vector as a sideband packet comprising an opcode and reserved fields before forwarding to upper protocol layers.

11. The apparatus of claim 10, wherein the processing circuitry implements a counter to detect a lack of clock signal increments for the defined number of unit intervals as the trigger.

12. The apparatus of claim 10, wherein multiple different triggers are defined by varying a duration of the clock signal remaining at the predetermined logic value.

13. The apparatus of claim 10, wherein the clock signal operates at a fixed frequency of 800 MHZ.

14. The apparatus of claim 10, wherein the defined number of unit intervals for the trigger is 4 UI.

15. The apparatus of claim 10, wherein the priority vector comprises 24 bits.

16. The apparatus of claim 10, wherein the priority vector includes a parity bit computed by XOR'ing the remaining bits of the priority vector.

17. The apparatus of claim 10, wherein the priority vector is formatted as a sideband packet for routing based on an opcode.

18. The apparatus of claim 10, wherein if a sideband link is idle, the sideband packet includes both the opcode and reserved fields.

19. A method for optimizing priority packet transmission, the method comprising:
receiving, by processing circuitry, a trigger indicating a switch to high priority data transfer based on a clock signal remaining at a predetermined logic value for a defined number of unit intervals;
transmitting a priority vector comprising a plurality of bits, wherein a bit is transmitted during a respective clock cycle and a clock toggles during transmission;
receiving a subsequent trigger indicating a resumption of a previous data transfer based on the clock signal again remaining at the predetermined logic value for the defined number of unit intervals; and
formatting the priority vector as a sideband packet comprising an opcode and reserved fields before forwarding to upper protocol layers.

20. The method of claim 19, further comprising implementing a counter to detect a lack of clock signal increments for the defined number of unit intervals as the trigger.
